(19) United States
(12) Patent Application Publication
(10) Pub. No.: US 2025/0372608 A1
(43) Pub. Date: Dec. 4, 2025

(54) SECONDARY BATTERY AND METHOD OF MANUFACTURING SECONDARY BATTERY

(71) Applicant: MURATA MANUFACTURING CO., LTD., Kyoto (JP)

(72) Inventors: Kazuya GOTO, Kyoto (JP); Kentaro YOSHIMURA, Kyoto (JP)

(21) Appl. No.: 19/303,952

(22) Filed: Aug. 19, 2025

Related U.S. Application Data
(63) Continuation of application No. PCT/JP2023/047343, filed on Dec. 28, 2023.

(30) Foreign Application Priority Data
Mar. 17, 2023 (JP) 2023-042903

(51) Int. Cl. H01M 4/04; B23K 26/362; B23K 101/36; H01M 4/38; H01M 10/052; H01M 10/0585

(52) U.S. Cl. CPC H01M 4/0471; H01M 4/0445; H01M 4/386; H01M 10/052; H01M 10/0585; B23K 26/362; B23K 2101/36

(57) ABSTRACT

A secondary battery using a negative electrode capable of improving a cycle characteristic, improving energy density, and improving safety of the secondary battery without provision of a recess or a protrusion in a negative electrode current collector. In the secondary battery, a negative electrode active material layer has a compound containing silicon. The negative electrode active material layer has a plurality of recessed portions in which a surface on an opposite side to a surface adjacent to the negative electrode current collector is recessed toward the negative electrode current collector side, and a protruding portion formed on both sides of the recessed portion.

### CROSS REFERENCE TO RELATED APPLICATIONS

The present application is a continuation of International Application No. PCT/JP2023/047343, filed on Dec. 28, 2023, which claims priority to Japanese Patent Application No. 2023-042903, filed on Mar. 17, 2023, the entire contents of which are incorporated herein by reference.

### BACKGROUND

The present application relates to a secondary battery and a method of manufacturing the secondary battery.

A secondary battery is described having a silicon-containing compound in a negative electrode. A technique in which a protrusion and a recess are provided in a negative electrode active material layer and a negative electrode current collector, and the protrusion and recess of the negative electrode active material layer and the negative electrode current collector overlap is disclosed.

### SUMMARY

The present application relates to a secondary battery and a method of manufacturing the secondary battery.

However, since the negative electrode current collector is also provided with a protrusion and a recess, the negative electrode current collector is easily broken, and there is a possibility that electronic conductivity is lowered.

Further, since a protrusion and a recess of the negative electrode current collector are formed by rolling by pressing a cutter, accuracy and regularity of the protrusion and the recess are insufficient, it is difficult to control basis weight, and there is a possibility that a cycle characteristic deteriorates.

Furthermore, when the current collector is exposed in a recessed portion, precipitation of Li metal occurs at an exposed portion, and there is a possibility that a cycle characteristic is further deteriorated.

The present disclosure relates to providing, in an embodiment, a secondary battery having improved energy density and cycle characteristic of the secondary battery.

A secondary battery according to one aspect of the present disclosure includes a positive electrode, a negative electrode, and a separator arranged between the positive electrode and the negative electrode, in which the negative electrode includes a negative electrode current collector and a negative electrode active material layer applied onto the negative electrode current collector, the negative electrode active material layer has a compound containing silicon, the negative electrode active material layer has a plurality of recessed portions in which a surface on an opposite side to a surface adjacent to the negative electrode current collector is recessed toward the negative electrode current collector, and a protruding portion formed on both sides of the recessed portion, the negative electrode current collector has a flat surface without a recess or a protrusion on a surface corresponding to a boundary between the recessed portion and the protruding portion, and a depth of the recessed portion is 10% or more and less than 100% with respect to a thickness of the negative electrode active material layer.

A method of manufacturing a secondary battery according to another aspect of the present disclosure is a method of manufacturing a secondary battery including a positive electrode, a negative electrode, and a separator arranged between the positive electrode and the negative electrode, in which a step of manufacturing the negative electrode includes a step of forming a negative electrode current collector, a step of forming a negative electrode active material layer on the negative electrode current collector, and a step of forming a recessed portion in the negative electrode active material layer, and the recessed portion is formed by laser ablation.

According to the present disclosure, it is possible to provide a secondary battery having improved energy density and cycle characteristic.

### BRIEF DESCRIPTION OF THE FIGURES

FIG. 1 is a perspective view illustrating a configuration of a secondary battery according to an embodiment.

FIG. 2 is a sectional view illustrating a configuration of a battery element illustrated in FIG. 1.

FIG. 3 is an explanatory view for explaining a step of forming a recessed portion in a negative electrode active material layer according to the embodiment.

FIG. 4 is a sectional view of a pattern in which the recessed portions of the negative electrode active material layer are formed in parallel in one direction.

FIG. 5 is a sectional view of a pattern in which the recessed portions of the negative electrode active material layer are formed in a lattice pattern in two directions.

FIG. 6 is a sectional view of a pattern in which the recessed portions of the negative electrode active material layer are formed in a lattice pattern in two directions.

FIG. 7 is a sectional view of a pattern in which the recessed portions of the negative electrode active material layer are formed in a triangular shape in three directions.

FIG. 8 is a sectional view of a pattern in which the recessed portions of the negative electrode active material layer are formed in a circular shape.

FIG. 9 is an enlarged sectional view illustrating a region A illustrated in FIG. 2 in a case where the recessed portions are formed in the negative electrode active material layer and a negative electrode current collector.

FIG. 10 is an enlarged sectional SEM photograph illustrating the recessed portion and a protruding portion.

### DETAILED DESCRIPTION

Hereinafter, an embodiment of a secondary battery of the present application will be described in further detail including with reference to the drawings. The present application is not limited by the embodiment. Each of the embodiments is an example, and it goes without saying that configurations shown in the different embodiments can be partly replaced or combined with each other.

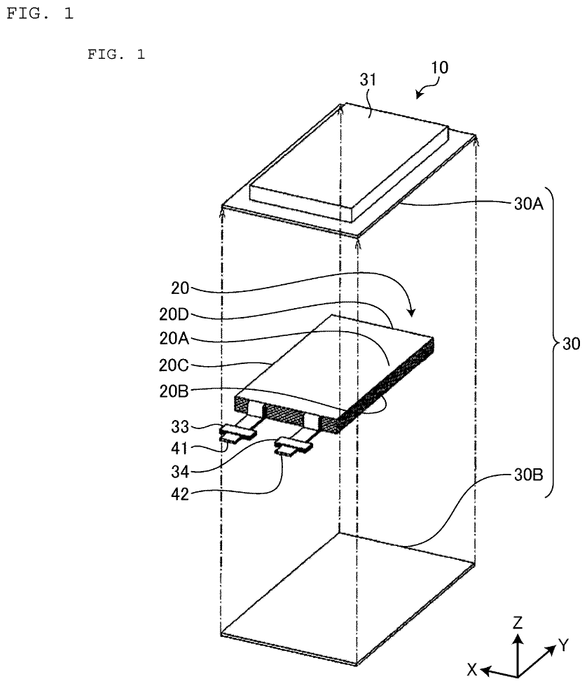

FIG. 1 is a perspective view illustrating a configuration of a secondary battery according to an embodiment. As illustrated in FIG. 1, a secondary battery 1 according to the embodiment includes a battery element 20, an exterior film 30, a positive electrode lead 41, and a negative electrode lead 42. The secondary battery 1 according to the present embodiment is a laminate film type non-aqueous electrolytic secondary battery using the exterior film 30, which is flexible and soft, for housing the battery element 20.

The exterior film 30 houses the battery element 20. As illustrated in FIG. 1, the exterior film 30 includes two film-shaped film members 30A and 30B separated from each other. The film members 30A and 30B are laminated with the battery element 20 interposed therebetween. Since outer peripheral edge portions of four sides of the exterior film 30 are bonded to each other, a bonded portion is formed at an outer peripheral edge portion of the exterior film 30. The exterior film 30 has a bag-like structure capable of enclosing the battery element 20 in the inside. Further, the film member 30A is provided with a depressed portion 31 for housing the battery element 20.

Each of the film members 30A and 30B is a three-layer laminate film in which a fusion layer, a metal layer, and a surface protective layer are laminated in this order from the inside. In a state where the film members 30A and 30B are laminated, outer peripheral edge portions of four sides of the fusion layers are fusion-bonded with each other. The fusion layer contains a polymer compound, and is, for example, polypropylene. The metal layer contains a metal material, and is, for example, aluminum. The surface protective layer contains a polymer compound, and is, for example, nylon. Note that outer peripheral edges of four sides of the fusion layer may be bonded to each other with an adhesive.

A configuration of the exterior film 30 is not particularly limited, but may be a single layer, two layers, or four or more layers.

An adhesive film 33 is inserted between the exterior film 30 and the positive electrode lead 41. An adhesive film 34 is inserted between the exterior film 30 and the negative electrode lead 42. Each of the adhesive films 33 and 34 is a member for preventing outside air or the like from entering the inside of the exterior film 30, and contains any one type or two or more types among polymer compounds such as polyolefin having adhesiveness to the positive electrode lead 41 and the negative electrode lead 42. Polyolefin is, for example, polyethylene, polypropylene, modified polyethylene, modified polypropylene, or the like. Note that either one or both of the adhesive films 33 and 34 may be omitted.

As illustrated in FIG. 1, the battery element 20 is housed inside the exterior film 30. The battery element 20 includes a positive electrode 210, a negative electrode 220, a separator 230, and a non-aqueous electrolyte solution (not illustrated). The battery element 20 having a rectangular shape has a main surface 20A and a main surface 20B on the opposite side to the main surface 20A. The main surface 20A has a side portion 20C in a longitudinal direction and a side portion 20D in a lateral direction.

The battery element 20 is a structure in which the positive electrode 210 and the negative electrode 220 are laminated with the separator 230 interposed therebetween. For this reason, the positive electrode 210 and the negative electrode 220 face each other with the separator 230 interposed therebetween.

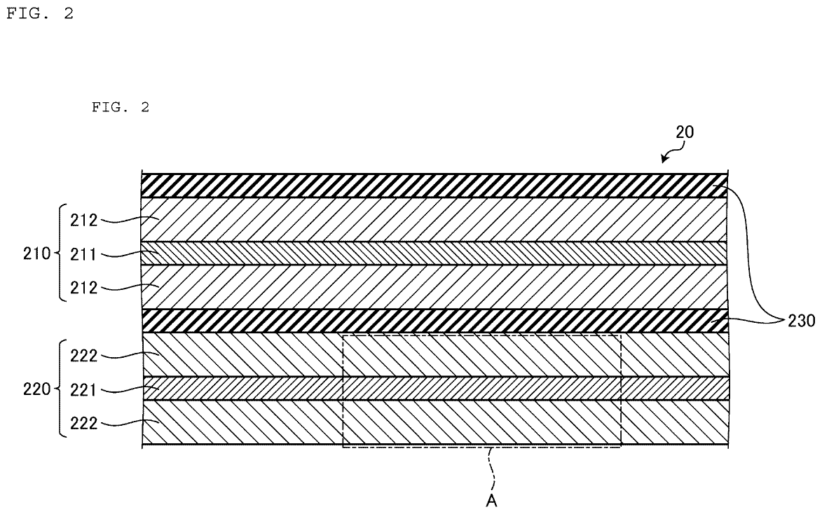

FIG. 2 is an enlarged sectional view illustrating a region A illustrated in FIG. 1. FIG. 2 is an enlarged sectional view illustrating a part of the positive electrode 210, the negative electrode 220, and the separator 230.

Next, a detailed material of the positive electrode 210, the negative electrode 220, the separator 230, and the non-aqueous electrolyte solution will be described.

As illustrated in FIG. 2, the positive electrode 210 includes a positive electrode current collector 211 and a positive electrode active material layer 212 provided on one surface or both surfaces of the positive electrode current collector 211.

The positive electrode active material layer 212 contains a positive electrode active material. The positive electrode active material is a positive electrode material capable of occluding and releasing lithium ions, and is, for example, lithium cobalt oxide (LCO), nickel, cobalt, and manganese (NCM), lithium nickel oxide (NCA), lithium iron phosphate (LFP), LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, LiMn₂O₄, and the like. A specific example of a phosphate compound uses LiFePO₄, LiMnPO₄, LiFe_{0.5}Mn_{0.5}PO₄, LiFe_{0.3}Mn_{0.7}PO₄, and the like. A specific example of a phosphate compound uses a compound such as LiFePO₄, LiMnPO₄, LiFe_{0.5}Mn_{0.5}PO₄, LiFe_{0.3}Mn_{0.7}PO₄ and the like. Further, the positive electrode active material layer 212 may be housed in, for example, the positive electrode current collector 211 having a case shape.

Further, the positive electrode active material layer 212 may have a conductive additive such as carbon on a surface of the positive electrode active material layer 212 in order to enhance conductivity of a positive electrode active material.

As the conductive additive of the positive electrode active material layer 212, a carbon material such as acetylene black (AB), carbon black, carbon nanotube (CNT), or carbon nanofiber (CNF) is used. The conductive additive is not limited to one type, and a plurality of conductive materials may be mixed and used. Note that, the conductive additive may be a metal material, a conductive polymer, or the like as long as the conductive additive has conductivity.

Furthermore, the positive electrode active material layer 212 may have a binding material (hereinafter referred to as a binder) on a surface of the positive electrode active material layer 212 in order to enhance adhesiveness of a positive active material.

As the binder of the positive electrode active material layer 212, PolyVinylidene DiFluoride (PVDF), carboxymethyl cellulose Natrium (CMC), styrene-butadiene rubber (SBR), or the like is used. However, a binding agent is not limited to the above, and only needs to be a compound containing any one type or two or more types of synthetic rubber, a polymer compound, and the like.

Content of the conductive additive with respect to a total amount of the positive electrode active material layer 212 is preferably 1 wt % or more and 10 wt % or less. Further, content of the binder with respect to a total amount of the positive electrode active material layer 212 is preferably 1 wt % or more and 10 wt % or less.

As illustrated in FIG. 2, the negative electrode 220 includes a negative electrode current collector 221 and a negative electrode active material layer 222 provided on one surface or both surfaces of the negative electrode current collector 221. The negative electrode 220 is an electrode having potential lower than that of the positive electrode 210.

The negative electrode active material layer 222 contains a negative electrode active material. The negative electrode active material contains, for example, a carbon material such as graphite. More specifically, a carbon material used for the negative electrode active material is, for example, at least one type or more of easily graphitizable carbon, non-graphitizable carbon, and graphite (natural graphite and artificial graphite). In particular, the negative electrode active material has a compound containing silicon to increase energy density of the secondary battery.

Further, the negative electrode active material layer 222 may have a conductive additive such as carbon on a surface of the negative electrode active material layer 222 in order to enhance conductivity of the negative electrode active material.

As the conductive additive of the negative electrode active material layer 222, the same material as the conductive additive contained in the positive electrode active material layer 212 described above is used. The conductive additive contained in the negative electrode active material layer 222 may be the same material as or a different material from the conductive additive contained in the positive electrode active material layer 212.

The negative electrode active material layer 222 may have a binding material (hereinafter referred to as a binder) on a surface of the negative electrode active material layer 222 in order to enhance adhesiveness of a negative electrode active material.

As the binder of the negative electrode active material layer 222, the same material as a binding agent contained in the positive electrode active material layer 212 described above is used. The binding agent in the negative electrode active material layer 222 may be the same material as or a different material from a binding agent contained in the positive electrode active material layer 212.

Content of the conductive additive with respect to a total amount of the negative electrode active material layer 222 is preferably 1 wt % or more and 10 wt % or less. Further, content of the binder with respect to a total amount of the negative electrode active material layer 222 is preferably 1 wt % or more and 10 wt % or less.

The separator 230 separates the positive electrode 210 and the negative electrode 220, and allows lithium ions to pass while preventing a short circuit of current caused by contact of both electrodes. In the example illustrated in FIG. 2, the separator 230 is provided between the positive electrode active material layer 212 of the positive electrode 210 and the negative electrode active material layer 222 of the negative electrode 220.

The separator 230 is formed of a thin film containing a polyolefin-based polymer compound such as polypropylene (PP) or polyethylene (PE). Note that the separator 230 is not limited to this, and may be formed of a porous film or the like formed of another resin material.

The non-aqueous electrolyte solution impregnates each of the positive electrode 210, the negative electrode 220, and the separator 230, and contains a solvent and an electrolyte salt (lithium salt). The non-aqueous electrolyte solution may contain an additive and the like, as necessary.

The non-aqueous electrolyte solution contains any one type or two or more types among non-aqueous solvents (organic solvents). An electrolyte solution containing a non-aqueous solvent is what is called a non-aqueous electrolyte solution. The non-aqueous solvent includes esters, ethers, and the like. More specifically, the non-aqueous solvent contains a carbonate ester-based compound, a carboxylic acid ester-based compound, a lactone-based compound, and the like.

The carbonate ester-based compound is a cyclic carbonate ester, a linear carbonate ester, and the like. The cyclic carbonate ester is, for example, ethylene carbonate and propylene carbonate. The linear carbonate ester may be, for example, dimethyl carbonate, diethyl carbonate, ethyl methyl carbonate, or the like.

The carboxylic acid ester-based compound is a linear carboxylic acid ester or the like. The linear carboxylic acid ester is, for example, methyl acetate, ethyl acetate, propyl acetate, methyl propionate, ethyl propionate, propyl propionate, methyl trimethylacetate, ethyl trimethylacetate, methyl butyrate, and ethyl butyrate. The linear carboxylic acid ester preferably has a boiling point of 100° C. or more and a viscosity of 0.9 mPa·s or less at 25° C.

The non-aqueous solvent may contain one or both of a cyclic carbonate ester (cyclic carbonate compound) and a linear carbonate ester (linear carbonate compound) together with a linear carboxylic acid ester. In the present embodiment, the non-aqueous solvent contains at least a cyclic carbonate compound and a linear carboxylic acid ester. A type of the cyclic carbonate ester may be only one type or two or more types. Similarly, a type of the linear carbonate ester may be only one type or two or more types.

The non-aqueous electrolyte solution may further contain a solvent in addition to the solvent. The lactone-based compound is a lactone or the like. Specific examples of the lactone include γ-butyrolactone and γ-valerolactone.

Note that the ethers may be compounds in which some of the ethers are fluorinated. The ethers are, for example, 1,2-dimethoxyethane, tetrahydrofuran, 1,3-dioxolane, 1,4-dioxane, and 1,1,2-tetrafluoroethyl 2,2,2,3,3-tetrafluoropropyl ether.

The electrolyte solution may further contain an electrolyte salt. The electrolyte salt is a light metal salt such as a lithium salt. The electrolyte salt contains any one type of, or two or more of types of lithium salts. The lithium salt contains, for example, lithium hexafluorophosphate (LiPF₆), lithium tetrafluoroborate (LiBF₄), lithium trifluoromethanesulfonate (LiCF₃SO₃), lithium bis (fluorosulfonyl) imide (LiN(FSO₂)₂), lithium bis (trifluoromethanesulfonyl) imide (LiN(CF₃SO₂)₂), lithium tris (trifluoromethanesulfonyl) methide (LiC(CF₃SO₂)₃), lithium bis (oxalato) borate (LiB(C₂O₄)₂), lithium monofluorophosphate (Li₂PFO₃), and lithium difluorophosphate (LiPF₂O₂). Content of the electrolyte salt (LiFSI) is, for example, 0.8 mol/kg or more and 1.2 mol/kg or less with respect to the non-aqueous solvent. More preferably, content of the electrolyte salt (LiFSI) is 0.9 mol/kg or more and 1.2 mol/kg or less.

The non-aqueous electrolyte solution contains an additive. The non-aqueous electrolyte solution may contain any one type, or two or more types of additives. This is because electrochemical stability of the electrolyte solution is improved, so that a decomposition reaction of the electrolyte solution is suppressed in a lithium ion secondary battery using the electrolyte solution. The additive is not particularly limited, and is, for example, an unsaturated cyclic carbonate ester, a fluorinated cyclic carbonate ester, a sulfonic acid ester, a phosphoric acid ester, an acid anhydride, and an isocyanate compound.

Specific examples of the unsaturated cyclic carbonate ester include vinylene carbonate, vinyl ethylene carbonate, and methylene ethylene carbonate. Specific examples of the fluorinated cyclic carbonate ester include monofluoro ethylene carbonate and difluoro ethylene carbonate. Specific examples of the sulfonic acid ester include propanesultone and propenesultone. Specific examples of the phosphoric acid ester include trimethyl phosphate and triethyl phosphate. Specific examples of the acid anhydride include succinic anhydride, 1,2-ethanedisulfonic acid anhydride, and 2-sulfobenzoic anhydride. Specific examples of the isocyanate compound include hexamethylene diisocyanate.

Next, a method of manufacturing the secondary battery 100 of a first embodiment will be described. In the method of manufacturing the secondary battery 100, after the positive electrode 210 and the negative electrode 220 are manufactured, the secondary battery 100 is manufactured using the positive electrode 210, the negative electrode 220, and the electrolyte solution.

First, the positive electrode current collector 211 is formed of a conductive material such as aluminum (Al). The positive electrode current collector 211 is not limited to aluminum, and may be another conductive material such as nickel or stainless steel.

First, 97.5 wt % of the positive electrode active material (for example, LCO), 1.0 wt % of the conductive additive, and 1.5 wt % of the binder are mixed and dispersed in a dispersant (for example, N-methyl-2-pyrrolidone (NMP)) to manufacture a paste-like positive electrode mixture slurry.

Next, the positive electrode mixture slurry is applied to both surfaces of the positive electrode current collector 211, dried, and then subjected to compression molding by a roll press machine, so that the positive electrode active material layers 212 are formed on both surfaces of the positive electrode current collector 211, so that the positive electrode 210 is manufactured. Note that a method of manufacturing the positive electrode 210 is not limited to the application method, and may be, for example, a gas phase method, a liquid phase method, a thermal spraying method, a firing method (sintering method), or a method of two or more types of these.

Next, a manufacturing step of the negative electrode 220 of the embodiment will be described. FIG. 3 is an explanatory view for explaining a step of forming a recessed portion in the negative electrode active material layer according to the embodiment. As illustrated in FIG. 3, the manufacturing step of the negative electrode 220 includes a step of forming the negative electrode current collector 221, a step of forming the negative electrode active material layer 222 on the negative electrode current collector 221, and a step of forming a recessed portion 223 in the negative electrode active material layer 222. Hereinafter, details of each step will be described.

First, the negative electrode current collector 221 is formed of a conductive material such as copper (Cu) (Step ST101). A material of the negative electrode current collector 221 is not limited to copper, and may be another conductive material such as nickel or stainless steel.

Next, 95.0 wt % of the negative electrode active material (for example, a mixture of artificial graphite:Si oxide=7:3), 1.0 wt % of the conductive additive, and 4.0 wt % of the binder are mixed and dispersed in water to manufacture a paste-like negative electrode mixture slurry. The negative electrode mixture slurry is applied onto both surfaces of the negative electrode current collector 221 (for example, Cu), dried, and then compression-molded with a roll press machine to manufacture the negative electrode 220 (Step ST102). Note that the method of manufacturing the negative electrode 220 is not limited to the application method, and may be, for example, a gas phase method, a liquid phase method, a thermal spraying method, a firing method (sintering method), or two or more types of these.

Then, after Step ST102, a plurality of the recessed portions 223 are formed in the negative electrode active material layer 222 such that a surface on the opposite side to a surface adjacent to the negative electrode current collector 221 is recessed toward the negative electrode current collector 221 side (Step ST103). In this case, a protruding portion 224 of the negative electrode active material layer is formed on both sides of the recessed portion 223. Since processing of forming the recessed portion 223 does not affect both surfaces of the negative electrode current collector 221, a surface of the negative electrode current collector 221 corresponding to a boundary between the recessed portion 223 and the protruding portion 224 is a flat surface without a recess or a protrusion. As described above, no step is formed between a surface of the negative electrode current collector 221 at a position overlapping the recessed portion 223 and a surface of the negative electrode current collector 221 at a position overlapping the protruding portion 224.

Laser ablation is applied as a processing means of the recessed portion 223. According to the laser ablation, photons of laser light cut an interatomic bond of the negative electrode active material layer, so that only a portion where laser light is absorbed is removed, and a recessed portion having a sharp edge with little thermal influence can be formed. A removed material is heated by absorbed laser energy and evaporated or sublimated. According to the laser ablation, processing of forming the recessed portion 223 does not affect both surfaces of the negative electrode current collector 221, and a surface of the negative electrode current collector 221 corresponding to a boundary between the recessed portion 223 and the protruding portion 224 becomes a flat surface without a recess or a protrusion.

As a laser to be used, an IR laser, an excimer laser, a YAG laser, a CO2 laser, or the like can be used, but the laser is not limited to these, and various lasers may be selected.

In the laser ablation, a form, wavelength, and power of laser light can be adjusted to adjust a width, depth, or pattern of a recessed portion.

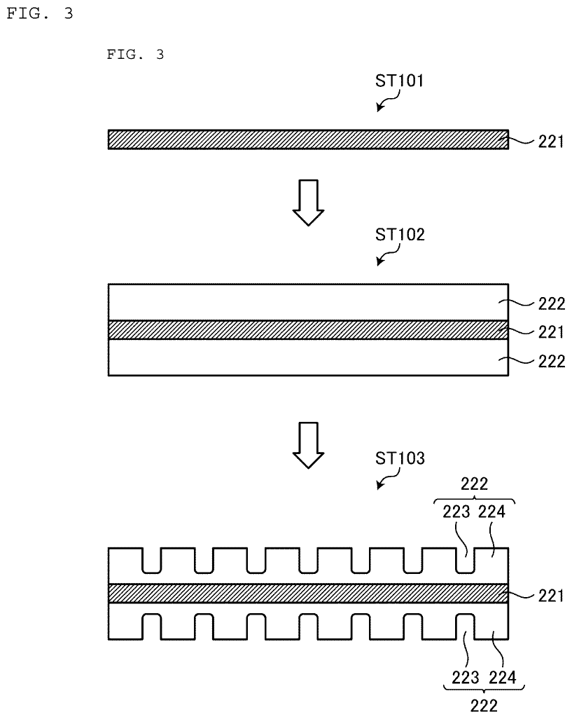

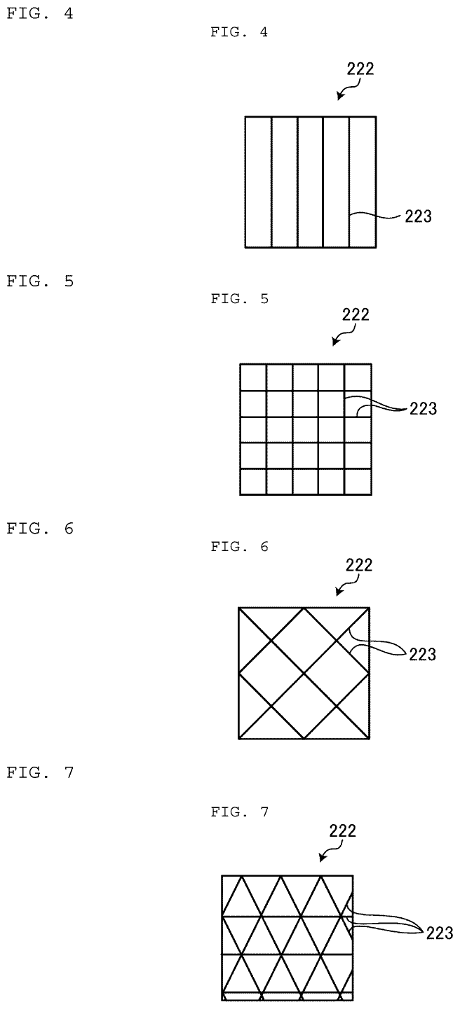

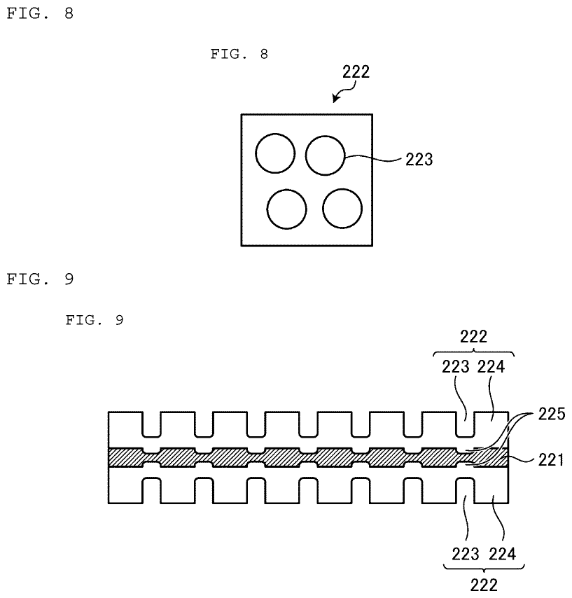

In Step ST102, a formation pattern of the recessed portion 223 of the negative electrode active material layer as illustrated in any of FIGS. 4 to 8 can be formed. FIG. 4 is a sectional view of a pattern in which the recessed portions of the negative electrode active material layer are formed in parallel in one direction. FIG. 5 is a sectional view of a pattern in which the recessed portions of the negative electrode active material layer are formed in a lattice pattern in two directions. FIG. 6 is a sectional view of a pattern in which the recessed portions of the negative electrode active material layer are formed in a lattice pattern in two directions. FIG. 7 is a sectional view of a pattern in which the recessed portions of the negative electrode active material layer are formed in a triangular shape in three directions. FIG. 8 is a sectional view of a pattern in which the recessed portions of the negative electrode active material layer are formed in a circular shape.

As illustrated in FIG. 4, a plurality of grooves of the recessed portions 223 adjacent to each other are formed at equal intervals in parallel in the same direction. As illustrated in FIG. 5, a plurality of grooves of the recessed portions 223 adjacent to each other are formed at equal intervals so as to intersect each other. A portion surrounded by the recessed portion 223 has a square shape in plan view. As illustrated in FIG. 6, a plurality of grooves of the recessed portions 223 adjacent to each other are formed at equal intervals so as to intersect each other. A portion surrounded by grooves of the recessed portion 223 has a rhombus shape in plan view. As illustrated in FIG. 7, a plurality of grooves of the recessed portions 223 adjacent to each other are formed at equal intervals so as to intersect each other. A portion surrounded by the recessed portion 223 has a triangular shape in plan view. As illustrated in FIG. 8, a plurality of grooves of the recessed portions 223 adjacent to each other are formed at equal intervals. The groove of the recessed portion 223 has a circular shape in plan view.

First, the positive electrode 210 and the negative electrode 220 are alternately laminated with the separator 230 interposed therebetween to form a laminate. The laminate has the same configuration as the configuration of the battery element 20 except that the positive electrode 210, the negative electrode 220, and the separator 230 are not impregnated with the electrolytic solution. Next, the positive electrode lead 41 is connected to the positive electrode current collector 211. Further, the negative electrode lead 42 is connected to the negative electrode current collector 221. A bonding method and a connection method are not particularly limited, but are any one type or two types or more of ultrasonic welding, resistance welding, soldering, and the like.

Next, after the laminate is housed in the depressed portion 31, the film members 30A and 30B are overlapped with each other with the laminate interposed therebetween. Next, outer peripheral edge portions of remaining three sides excluding an outer peripheral edge portion of one side of each of the film members 30A and 30B are bonded to each other to house the laminate inside the exterior film 30 having a bag shape. A method of bonding the film members 30A and 30B to each other is not particularly limited, but a thermal fusion method may be used, or an adhesive may be used.

Then, after the electrolyte solution is injected into the exterior film 30 having a bag shape, outer peripheral edge portions of the remaining one side of each of the film members 30A and 30B are bonded to each other to seal the exterior film 30. In this case, the adhesive film 33 is inserted between the exterior film 30 and the positive electrode lead 41, and the adhesive film 34 is inserted between the exterior film 30 and the negative electrode lead 42. By this, since the laminate is impregnated with the electrolyte solution, the battery element 20 is manufactured, and the battery element 20 is housed inside the exterior film 30 while the positive electrode lead 41 and the negative electrode lead 42 are led out from the inside to the outside of the exterior film 30. Therefore, the battery element 20 is sealed in the exterior film 30. By this, the secondary battery 10 is manufactured.

As described above, both surfaces of the negative electrode current collector 221 are flat surfaces without a recess or a protrusion. The negative electrode active material layer 222 has the recessed portion 223 in which a surface on the opposite side to a surface adjacent to the negative electrode current collector 221 is recessed toward the negative electrode current collector 221 side. Since the recessed portion 223 does not affect a surface of the negative electrode current collector 221, no wrinkle is generated on a surface of the negative electrode current collector 221. By this, expansion of the negative electrode active material can be absorbed by the recessed portion 223, and expansion in a thickness direction is suppressed, so that energy density increases and a cycle characteristic can be improved.

A depth of the recessed portion 223 is 10% or more and less than 100% with respect to a thickness of the negative electrode active material layer 222. The deeper the depth of the recessed portion 223 formed on one surface of the negative electrode active material layer 222, the easier it is to absorb expansion of the negative electrode active material. For this reason, when the recessed portion 223 is present only on a surface of the negative electrode active material layer, and a depth of the recessed portion 223 is 10% or more and less than 100% with respect to a thickness of the negative electrode active material layer 222, a cycle retention rate can be improved as compared with a case where the recessed portion 223 is not provided on a surface of the negative electrode active material layer 222.

As a desirable aspect, an oxygen ratio in constituent elements on a surface of the recessed portion 223 is larger than an oxygen ratio in constituent elements on a surface of the protruding portion 224. When the recessed portion 223 is formed on one surface of the negative electrode active material layer 222, a difference in oxygen ratio occurs between a surface of the recessed portion 223 of the negative electrode active material layer 222 and a surface of the protruding portion 224. Since an oxygen-rich layer is formed on a surface of the recessed portion 223 of the negative electrode active material layer 222 rather than a surface of the protruding portion 224, a cycle retention rate can be improved as compared with a case where the recessed portion 223 is not provided on a surface of the negative electrode active material layer 222.

As a desirable aspect, a width of the recessed portion 223 after full charge is 0.01 μm or more and 20 μm or less. The larger the width of the recessed portion after full charge, the lower the energy density; however, in a case where the width is 0.01 μm or more and 20 μm or less, the energy density can be improved because the width is not too large. Here, the full charge means that charge is performed until a state of charge of the secondary battery reaches 100% within an operating voltage range of the secondary battery in a case where the range is designated, such that potential of the negative electrode 220 is 0.1 V or less based on lithium metal.

As a desirable aspect, the recessed portion 223 is formed by laser ablation. Since the recessed portion 223 is formed by laser ablation, the recessed portion 223 is uniformly formed on the entire surface of the negative electrode active material layer 222 as compared with a processing method such as rolling, so that energy density can be improved and a cycle characteristic can be improved. Note that an oxygen ratio in an oxygen-rich layer on a surface of the recessed portion 223 of the negative electrode active material layer 222 can be appropriately changed by a laser processing condition, and a condition based on processing time, pulse width of a laser, and laser output.

As a desirable aspect, a step of charging while pressurizing the entire secondary battery 1 is included. By charging while pressurizing the entire secondary battery, expansion of the negative electrode active material layer 222 can be absorbed by the recessed portion, energy density can be improved, and a cycle characteristic can be improved.

### Evaluation

An evaluation test described below is performed on Examples 1 to 7 and Comparative Examples 1 to 4.

### [Capacity Evaluation Test]

Using the secondary battery 1 manufactured using the above-described method of manufacturing a secondary battery, constant current charge was performed up to 4.4 V at 0.1 C of design capacity while pressurization was performed in a thickness direction of the secondary battery, and then constant voltage charge was performed up to 0.025 C at 4.40 V. After the above, constant current discharge was performed up to 3.0 V at 0.1 C, and initial capacity was measured. A pressurization condition can be performed, for example, at 1.0 MPa.

### [Energy Density Evaluation Test]

After charge, thickness of a secondary battery was measured using a u gauge. Volume was calculated from an area of the negative electrode 220 and thickness of the secondary battery 1. Energy density was calculated by dividing the discharge capacity calculated in the capacity evaluation test by the calculated volume.

### [Cycle Evaluation Test]

Constant current charge was performed up to 4.4 V at design capacity of 0.5 C, subsequently constant voltage charge was performed at 4.40 V up to 0.025 C, and constant current discharge performed at 0.5 C until 3.0 V was reached in one cycle was repeated up to 100 cycles. A retention rate at a 100th cycle was calculated.

### [Composition Evaluation]

As a measuring apparatus, Hitachi FE-SEM S-4800 was used. FIG. 10 is an enlarged sectional SEM photograph showing a recessed portion and a protruding portion of the negative electrode active material. As illustrated in FIG. 10, composition evaluation was performed on a bottom surface of the recessed portion 223 and a surface of the protruding portion 224 before charge and discharge by using a Scanning Electron Microscope (SEM). Oxygen concentration was calculated from a constituent element excluding metal of the negative electrode current collector 221. The oxygen concentration is X1 for the recessed portion 223 and X2 for the protruding portion 224.

### [Observation of Electrode Surface]

As a measuring apparatus, Hitachi FE-SEM S-4800 was used. Constant current charge was performed to 4.4 V at design capacity of 0.1 C, and then constant voltage charge was performed to 0.025 C at 4.40 V. This state was set to full charge, the charged secondary battery was disassembled, a surface of the negative electrode was observed, and width of the recessed portion 223 was measured. As illustrated in FIG. 10, width of the recessed portion 223 was set to W1.

### [Electrode Breaking Strength Evaluation Test]

As a measuring apparatus, Series5560 manufactured by INSTRON was used. A tensile strength test of the negative electrode 220 was performed, and fracture strain was measured from a stress-strain curve. The fracture strain is magnitude of strain until fracture in a case where stress is increased, and therefore, the larger the numerical value, the less likely the fracture is to occur, and the smaller the numerical value, the more likely the fracture is to occur.

### Example 1

A formation pattern of the recessed portions 223 in Example 1 is a pattern in which the recessed portions of the negative electrode active layer are formed in a lattice pattern in two directions (see FIG. 5). In Example 1, the recessed portion 223 is formed by laser ablation, and a depth of the recessed portion 223 is 10% with respect to a thickness of the negative electrode active material layer 222. The width W1 of the recessed portion 223 is 20 μm. Note that the laser ablation is denoted as laser in a column of manufacturing method in Table 1.

### Example 2

In Example 2, the secondary battery 1 was manufactured in the same manner as in Example 1 except that a depth of the recessed portion 223 was 50% with respect to a thickness of the negative electrode active material layer 222, and the various evaluation tests described above were performed. An obtained result is shown in Table 1.

### Example 3

In Example 3, the secondary battery 1 was manufactured in the same manner as in Example 1 except that a depth of the recessed portion 223 was 90% with respect to a thickness of the negative electrode active material layer 222, and the various evaluation tests described above were performed. An obtained result is shown in Table 1.

### Example 4

In Example 4, the secondary battery 1 was manufactured in the same manner as in Example 1 except that oxygen concentration was X1=X2 and a processing means of the recessed portion 223 was rolling using a mesh, and the various evaluation tests described above were performed. An obtained result is shown in Table 1. The mesh is a processing tool in which a stainless steel thread is formed into a lattice shape. Note that the rolling using the mesh is described as rolling in the column of manufacturing method in Table 1.

### Example 5

In Example 5, the secondary battery 1 was manufactured in the same manner as in Example 1 except that the width W1 of the recessed portion 223 was 40 μm and a depth of the recessed portion 223 was 90% with respect to a thickness of the negative electrode active material layer 222, and the various evaluation tests described above were performed. An obtained result is shown in Table 1.

### Example 6

In Example 6, the secondary battery 1 was manufactured in the same manner as in Example 1 except that the width W1 of the recessed portion 223 was 10 μm and a depth of the recessed portion 223 was 90% with respect to a thickness of the negative electrode active material layer 222, and the various evaluation tests described above were performed. An obtained result is shown in Table 1.

### Example 7

In Example 7, the secondary battery 1 was manufactured in the same manner as in Example 1 except that the width W1 of the recessed portion 223 was 0.01 μm and a depth of the recessed portion 223 was 90% with respect to a thickness of the negative electrode active material layer 222, and the various evaluation tests described above were performed. An obtained result is shown in Table 1.

### Comparative Example 1

In Comparative Example 1, the secondary battery 1 was manufactured in the same manner as in Example 1 except that the recessed portion 223 was not formed, and the above-described various evaluation tests were performed. An obtained result is shown in Table 1. Note that the fact that the recessed portion 223 is not formed is described as no processing in the column of manufacturing method in Table 1.

### Comparative Example 2

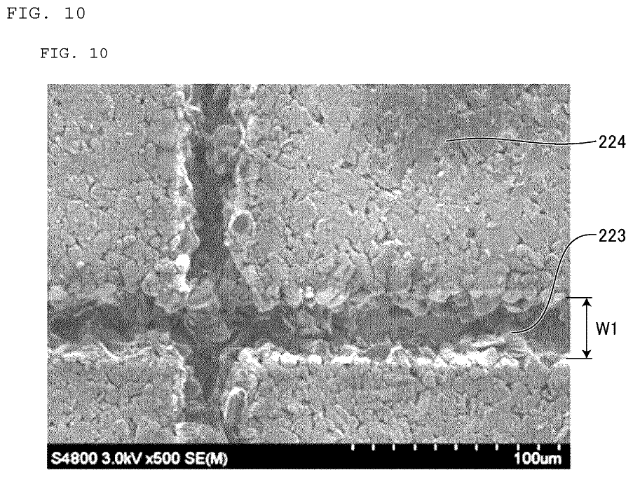

In Comparative Example 2, the secondary battery 1 was manufactured in the same manner as in Example 1, except that a recessed portion 225 was provided in the negative electrode current collector 221, a depth of the recessed portion 223 was 90% with respect to a thickness of the negative electrode active material layer 222, and a processing means of the recessed portion 223 and the recessed portion 225 was rolling using a mesh, and the various evaluation tests described above were performed. An obtained result is shown in Table 1. FIG. 9 is an enlarged sectional view illustrating the region A illustrated in FIG. 2 in a case where the recessed portions are formed in the negative electrode active material layer and the negative electrode current collector. As illustrated in FIG. 9, when processing for forming the recessed portion 223 is rolling, a surface of the negative electrode current collector 221 is easily affected, and a step is generated between a surface of the negative electrode current collector 221 at a position overlapping the recessed portion 223 and a surface of the negative electrode current collector 221 at a position overlapping the protruding portion 224, so that the recessed portion 225 is formed. As illustrated in FIG. 9, since a recess and a protrusion are formed in the negative electrode current collector 221, fracture is easily generated in the negative electrode current collector 221.

### Comparative Example 3

In Comparative Example 3, the secondary battery 1 was manufactured in the same manner as in Example 1 except that the recessed portion 225 was provided only in the negative electrode current collector 221 and a processing means of the recessed portion 225 was rolling using a mesh, and the various evaluation tests described above were performed. An obtained result is shown in Table 1.

### Comparative Example 4

In Comparative Example 4, the secondary battery 1 was manufactured in the same manner as in Example 1 except that a depth of the recessed portion 223 was 5% with respect to a thickness of the negative electrode active material layer 222, and the various evaluation tests described above were performed. An obtained result is shown in Table 1.

### Comparative Example 5

In Comparative Example 5, the secondary battery 1 was manufactured in the same manner as in Example 1 except that a depth of the recessed portion 223 was 100% with respect to a thickness of the negative electrode active material layer 222, and the various evaluation tests described above were performed. An obtained result is shown in Table 1.

TABLE 1

| | Negative | | | | | | | | |
|---|---|---|---|---|---|---|---|---|---|
| | electrode | Negative | Depth of | | Width of | | | | |
| | active | electrode | recessed | | recessed | | | | |
| | material | current | portion | Relationship | portion | | | | |
| | layer | collector | of | between | during | | E | Cycle | |
| | recessed | recessed | mixture | compositions | charge | Manufacturing | density | retention | Fracture |
| | portion | portion | [%] | X1 and X2 | W1 [μm] | method | ratio | rate | strain |
| Comparative | x | x | 0 | — | 0 | No | 1.000 | 80% | — |
| Example 1 | | | | | | processing | | | |
| Comparative | ∘ | ∘ | 90 | — | 20 | Rolling | 0.941 | 70% | 0.40% |
| Example 2 | | | | | | | | | |
| Comparative | x | ∘ | 0 | — | 0 | Rolling | 0.812 | 79% | 0.34% |
| Example 3 | | | | | | | | | |
| Comparative | ∘ | x | 5 | — | 20 | Laser | 0.997 | 80% | — |
| Example 4 | | | | | | | | | |
| Example 1 | ∘ | x | 10 | X1 > X2 | 20 | Laser | 1.002 | 84% | — |
| Example 2 | ∘ | x | 50 | — | 20 | Laser | 1.014 | 86% | — |
| Example 3 | ∘ | x | 90 | — | 20 | Laser | 1.025 | 89% | 1.01% |
| Comparative | ∘ | x | 100 | — | 20 | Laser | 0.939 | 5.3% | — |
| Example 5 | | | | | | | | | |
| Example 2 | ∘ | x | 10 | X1 = X2 | 20 | Rolling | 1.002 | 81% | — |
| Example 5 | ∘ | x | 90 | — | 40 | Laser | 0.824 | 82% | — |
| Example 6 | ∘ | x | 90 | — | 10 | Laser | 1.026 | 91% | — |
| Example 7 | ∘ | x | 90 | — | 0.01 | Laser | 1.062 | 94% | — |

Note that the embodiment described herein is intended to facilitate understanding of the present application, but not to construe the present application in any limited way. The present application can be modified or improved without departing from the gist of the present application, and equivalents of the present application are also included in the present application. Further, a depth and a width of the recessed portion are shown as average values in consideration of variations.

As a result of electrode surface observation, one in which a recessed portion was observed was given a rating of A, and one in which no recessed portion was observed (flat one) was given a rating of B, and the rating of A was indicated by “o” in Table 1, and the rating of B was indicated by “x” in Table 1.

When Example 1 and Example 4 are compared, X1=X2 in the case of Example 4, but since rolling is performed using a mesh as a method of forming a recessed portion in a negative electrode terminal, an oxygen ratio is unchanged and is 1.0. In the case of Example 1, X1>X2, but X1 is, for example, 16.2%, and X2 is, for example, 11.5%. A ratio of oxygen concentration is 1.4. This is because the recessed portion 223 is formed by laser ablation in Example 1, and thus it is possible to form an oxygen-rich layer on a bottom surface of the recessed portion 223 by leaving a thermal history by a laser on a bottom surface of the recessed portion, and oxygen concentration of the bottom surface of the recessed portion 223 becomes higher than that on a surface of the protruding portion 224. As a result, a cycle retention rate is improved.

Depths of the recessed portions 223 in Examples 1, 2, and 3 are 10%, 50%, and 90%, respectively, with respect to a thickness of the negative electrode active material layer 222 provided with the recessed portions 223. As compared with Comparative Example 1, an energy density ratio is improved, and a cycle retention rate is improved. Note that an energy density ratio is expressed as an E density ratio in Table 1.

On the other hand, a depth of the recessed portion 223 of Comparative Example 4 is 5% with respect to a thickness of the negative electrode active material layer 222. As compared with Example 1, an energy density ratio decreases. This is because an effect of suppressing expansion due to a charge-discharge cycle is not high in the shallow recessed portion of about 5%.

Further, a depth of the recessed portion 223 of Comparative Example 5 is 100% with respect to a thickness of the negative electrode active material layer 222. As compared with Comparative Example 1, an energy density ratio decreases, and a cycle retention rate deteriorates.

Therefore, by setting a depth of the recessed portion 223 to 10% or more and less than 100% with respect to a thickness of the negative electrode active material layer 222, energy density can be improved and a cycle characteristic can be improved.

In Comparative Example 2, since the recessed portion 225 is rolled using a mesh for the negative electrode current collector 221, regularity and accuracy of a protrusion and a recess are insufficient as compared with Comparative Example 1, and for this reason, an energy density ratio decreases and a cycle retention rate deteriorates. Further, since a current collecting foil has a recess and a protrusion, fracture strain is small, and a current collecting foil of the negative electrode current collector 221 is prone to fracture.

In Comparative Example 3, since a mesh is used for the negative electrode current collector 221 and the recessed portion 225 is rolled, an energy density ratio decreases and a cycle retention rate deteriorates as compared with Comparative Example 1. Further, since a current collecting foil has a recess and a protrusion, fracture strain is small, and a current collecting foil of the negative electrode current collector 221 is prone to fracture.

The widths W1 of the recessed portions 223 of Examples 3, 6, and 7 are 20 μm, 10 μm, and 0.01 μm, respectively. As compared with Comparative Example 1, an energy density ratio is improved, and a cycle retention rate is improved.

On the other hand, the width W1 of the recessed portion 223 of Example 5 is 40 μm. As compared with Comparative Example 1, an energy density ratio decreases, and a cycle retention rate deteriorates.

Therefore, by setting the width W1 of the recessed portion 223 to 0.01 μm or more and 20 μm or less, energy density can be improved and a cycle characteristic can be improved.

Note that the present disclosure may be a combination of configurations below according to an embodiment.

(1)

A secondary battery including:
a positive electrode;
a negative electrode; and
a separator arranged between the positive electrode and the negative electrode,
in which the negative electrode includes a negative electrode current collector and a negative electrode active material layer applied onto the negative electrode current collector,
the negative electrode active material layer has a compound containing silicon,
the negative electrode active material layer has a plurality of recessed portions in which a surface on an opposite side to a surface adjacent to the negative electrode current collector is recessed toward the negative electrode current collector, and a protruding portion formed on both sides of the recessed portion,
the negative electrode current collector has a flat surface without a recess or a protrusion on a surface corresponding to a boundary between the recessed portion and the protruding portion, and
a depth of the recessed portion is 10% or more and less than 100% with respect to a thickness of the negative electrode active material layer.
   (2)

The secondary battery according to (1), in which
an oxygen ratio in constituent elements of the recessed portion is larger than that of the protruding portion.
   (3)

The secondary battery according to (1) or (2), in which
a width of the recessed portion at time of full charge is 0.01 μm or more and 20 μm or less.
   (4)

A method of manufacturing a secondary battery including a positive electrode, a negative electrode, and a separator arranged between the positive electrode and the negative electrode,
in which a step of manufacturing the negative electrode includes:
a step of forming a negative electrode current collector;
a step of forming a negative electrode active material layer on the negative electrode current collector; and
a step of forming a recessed portion in the negative electrode active material layer, and
the recessed portion is formed by laser ablation.
   (5)

The method of manufacturing a secondary battery according to (4), further including:
a step of assembling the negative electrode manufactured in the step of manufacturing the negative electrode, the positive electrode, and the separator, and charging the secondary battery impregnated with an electrolyte solution while pressurizing the entire secondary battery in a thickness direction.
   (6)

The method of manufacturing a secondary battery according to (4) or (5), in which
an oxygen ratio in constituent elements of the recessed portion is larger than that of a protruding portion formed on both sides of the recessed portion.
   (7)

The method of manufacturing a secondary battery according to any one of (4) to (6), in which
a width of the recessed portion at time of full charge is 0.01 μm or more and 20 μm or less.
   (8)

The method of manufacturing a secondary battery according to any one of (4) to (7), in which
a depth of the recessed portion is 10% or more and less than 100% with respect to a thickness of the negative electrode active material layer.

### DESCRIPTION OF REFERENCE SYMBOLS

1: Secondary battery
210: Positive electrode
211: Positive electrode current collector
212: Positive electrode active material layer
220: Negative electrode
221: Negative electrode current collector
222: Negative electrode active material layer
223: Recessed portion
224: Protruding portion
225: Recessed portion
230: Separator
W1: Width of recessed portion

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
a separator arranged between the positive electrode and the negative electrode,
wherein the negative electrode includes a negative electrode current collector and a negative electrode active material layer applied onto the negative electrode current collector,
the negative electrode active material layer has a compound containing silicon,
the negative electrode active material layer has a plurality of recessed portions in which a surface on an opposite side to a surface adjacent to the negative electrode current collector is recessed toward the negative electrode current collector, and a protruding portion formed on both sides of the recessed portion,
the negative electrode current collector has a flat surface without a recess or a protrusion on a surface corresponding to a boundary between the recessed portion and the protruding portion, and
a depth of the recessed portion is 10% or more and less than 100% with respect to a thickness of the negative electrode active material layer.

2. The secondary battery according to claim 1, wherein an oxygen ratio in constituent elements of the recessed portion is larger than that of the protruding portion.

3. The secondary battery according to claim 1, wherein a width of the recessed portion at time of full charge is 0.01 μm or more and 20 μm or less.

4. A method of manufacturing a secondary battery including a positive electrode, a negative electrode, and a separator arranged between the positive electrode and the negative electrode, the method comprising:
manufacturing the negative electrodeincluding:
forming a negative electrode current collector;
forming a negative electrode active material layer on the negative electrode current collector; and
forming a recessed portion in the negative electrode active material layer, and
the recessed portion is formed by laser ablation.

5. The method of manufacturing a secondary battery according to claim 4, further comprising:
assembling the negative electrode, the positive electrode, and the separator, and charging the secondary battery impregnated with an electrolyte solution while pressurizing the entire secondary battery in a thickness direction.

6. The method of manufacturing a secondary battery according to claim 4, wherein an oxygen ratio in constituent elements of the recessed portion is larger than that of a protruding portion formed on both sides of the recessed portion.

7. The method of manufacturing a secondary battery according to any one of claim 4, wherein a width of the recessed portion at time of full charge is 0.01 μm or more and 20 μm or less.

8. The method of manufacturing a secondary battery according to any one of claim 4, wherein a depth of the recessed portion is 10% or more and less than 100% with respect to a thickness of the negative electrode active material layer.
